(19) United States
(12) Patent Application Publication
(10) Pub. No.: US 2018/0374208 A1
(43) Pub. Date: Dec. 27, 2018

(54) INTERFACE OPERATING METHOD AND RELATED MOBILE DEVICE

(71) Applicant: VIVOTEK INC., New Taipei City (TW)

(72) Inventors: Cheng-Chieh Liu, New Taipei City (TW); Yi-Hsuen Shih, New Taipei City (TW)

(21) Appl. No.: 16/009,234

(22) Filed: Jun. 15, 2018

(30) Foreign Application Priority Data
Jun. 21, 2017 (TW) 106120685

(51) Int. Cl. G06T 7/00; G06T 7/11; G06T 7/73

(52) U.S. Cl. CPC G06T 7/0008; G06T 2200/28; G06T 7/73; G06T 7/11

(57) ABSTRACT

An interface operating method is applied to a mobile device connected with a camera apparatus in a remote controlling manner to guide a movement of a user to compute a position parameter of the camera apparatus. The interface operating method includes displaying an image frame captured by the camera apparatus, displaying at least one indicating mark on the image frame, identifying whether a position of an object appeared on the image frame overlaps the at least one indicating mark, and acquiring coordinates of a plurality of feature point coordinates of the object according to an identifying result so as to compute the position parameter of the camera apparatus relative to a reference plane whereon the object is located.

### BACKGROUND OF THE INVENTION

### 1. Field of the Invention

The present invention relates to an interface operating method and a related mobile device, and more particularly, to an interface operating method capable of estimating a parameter of a camera apparatus in a remote manner and a related mobile device.

### 2. Description of the Prior Art

A conventional image monitoring apparatus can be disposed on the public building to monitor moving objects inside a monitoring region. When the image monitoring apparatus is installed on a supporter, a height of the supporter and an inclination angle of the image monitoring apparatus relative to the supporter are unknown. The user needs to measure the height and the inclination angle, and then sizes of the object appeared within the image can be estimated by software via measured values processed. The estimated sizes of the object may be incorrect due to lack of installed information (such as the measured values), which results in poor accuracy. Another conventional image monitoring apparatus may analyze a large number of sizes of the moving object within the monitoring region over a long period of time, so as to estimate the height of the supporter and the inclination angle of the image monitoring apparatus; the correct sizes of the object within the image can be computed via the estimated height and the estimated inclination angle. However, the large-scale computation method spends operation loading and operation periods for the correct estimated value. Design of an operating method capable of estimating the height of the supporter and the inclination angle of the image monitoring apparatus automatically and efficiently to increase the detection accuracy of the moving object by less operation loading is an important issue in the monitoring industry.

### SUMMARY OF THE INVENTION

The present invention provides an interface operating method capable of estimating a parameter of a camera apparatus in a remote manner and a related mobile device for solving above drawbacks.

According to the claimed invention, an interface operating method includes displaying an image frame captured by a camera apparatus, displaying at least one indicating mark on the image frame, identifying whether a position of an object appeared on the image frame is overlapped with the at least one indicating mark, and acquiring a plurality of feature point coordinates of the object in accordance with an identifying result for computing a position parameter of the camera apparatus relative to a reference plane whereon the object is located.

According to the claimed invention, a mobile device is connected with a camera apparatus in a remote controlling manner for guiding a movement of a user to estimate a position parameter of the camera apparatus. The mobile device includes a screen and a processor. The screen is configured to display an image frame captured by the camera apparatus. The processor is electrically connected to the screen and configured to display at least one indicating mark on the image frame, to identify whether a position of an object appeared on the image frame is overlapped with the at least one indicating mark, and to acquire a plurality of feature point coordinates of the object in accordance with an identifying result for computing position parameter of the camera apparatus relative to a reference plane whereon the object is located.

The interface operating method of the present invention is applied to the mobile device. The user can move inside a place (such as the monitoring region) captured by the camera apparatus in accordance with the image frame of the mobile device. The interface operating method can show the plurality of indicating marks on the image frame corresponding to the monitoring region. The user can move to some specific positions by following the indicating marks, and the camera apparatus can capture patterns about the user. The interface operating method can estimate the vector of the patterns about the user via the feature point coordinates of the object, and compare the estimated value with the known height of the user to compute the height and the inclination angle of the camera apparatus relative to the reference plane. The estimated value can be similar to the known height of the user by the object overlapping plenty of the indicating marks within the image frame. The present invention further provides several verification procedures to ensure the accuracy of the position parameter about the camera apparatus.

The user can independently operate the interface operating method of the present invention without an extra cooperator near by the camera apparatus. The user can look at the screen of the mobile device to decide the following motion and positions. The user does not move to useless positions so that an operation period can be economized and operation efficiency can be increased. The interface operating method can decrease computation loading by computing the computing completion rate of the position parameter according to collected data (which means the feature point coordinates of the object overlapped with the indicating mark), so as to point out that the interface operating method is continued or completed. The user can utilize the verification procedures of the interface operating method to check the accuracy of the position parameter when still being positioned in the monitoring region. As the accuracy is insufficient, the interface operating method can be executed again to suggest the movement of the user for overlapping the indicating mark and acquiring the updated feature point coordinates and the updated position parameter The computer screen of the camera apparatus may be distant from the monitoring region, for example, the monitoring region is about an entrance of a market and the computer screen is set in an administration center of the market, so that the user having the mobile device with the interface operating method of the present invention does not need to move back and forth between the entrance and the administration center.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an application diagram of a mobile device and a camera apparatus according to an embodiment of the present invention.

FIG. 2 is a functional block diagram of the mobile device according to the embodiment of the present invention.

FIG. 3 is a diagram of an image frame I captured by the camera apparatus according to the embodiment of the present invention.

FIG. 4 is a flow chart of the interface operating method according to the embodiment of the present invention.

FIG. 5 and FIG. 6 respectively are diagrams of frames about a screen in different interface operating modes according to the embodiment of the present invention.

FIG. 7 and FIG. 8 respectively are diagrams of an image frame having an indicating mark in different interface operating modes according to another embodiment of the present invention.

### DETAILED DESCRIPTION

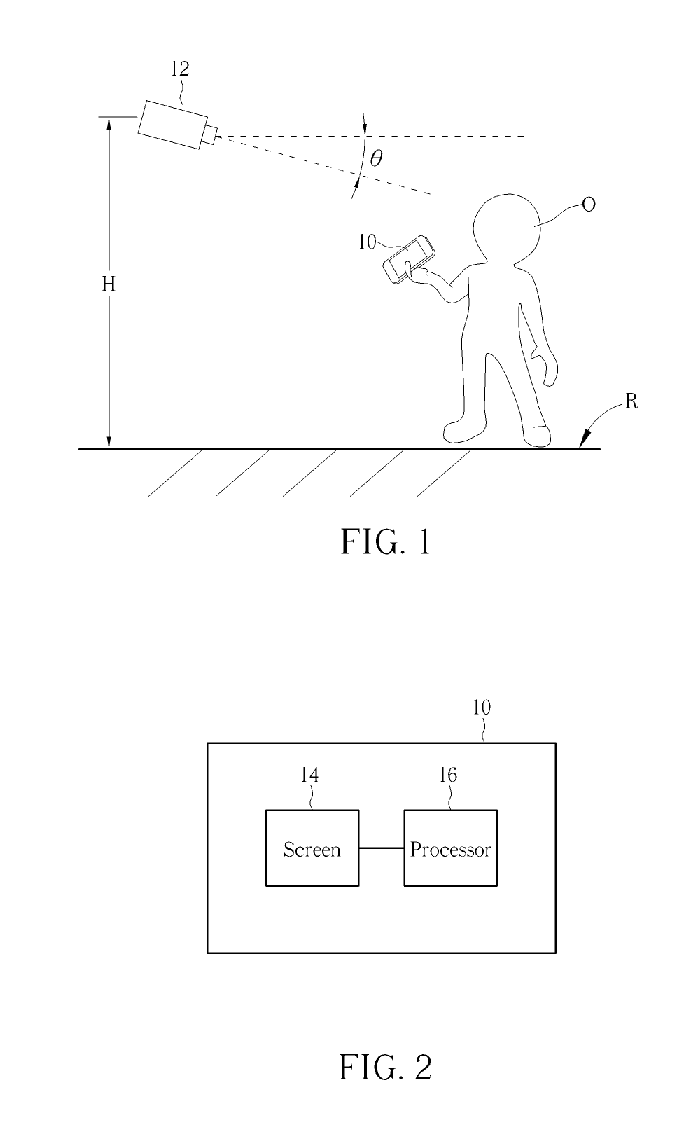

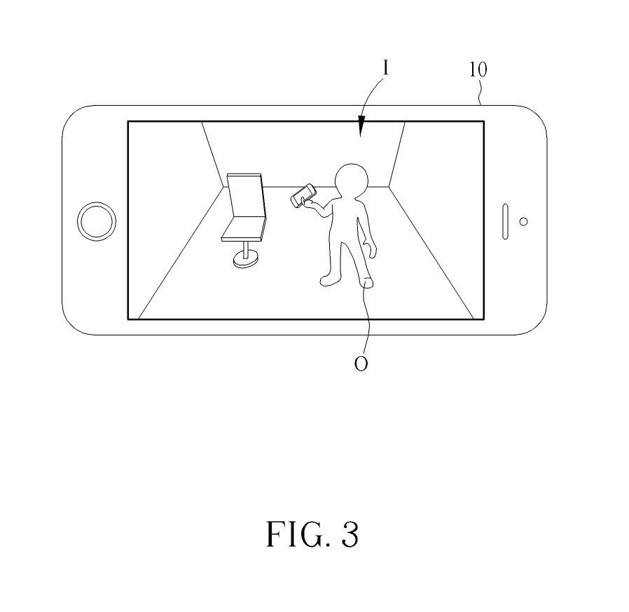

Please refer to FIG. 1 to FIG. 3. FIG. 1 is an application diagram of a mobile device 10 and a camera apparatus 12 according to an embodiment of the present invention. FIG. 2 is a functional block diagram of the mobile device 10 according to the embodiment of the present invention. FIG. 3 is a diagram of an image frame I captured by the camera apparatus 12 according to the embodiment of the present invention. The mobile device 10 can include a screen 14 and a processor 16 electrically connected with each other. The screen 14 is configured to display the image frame I. The processor 16 is configured to execute an interface operating method for guiding a movement of a user within a monitoring region of the camera apparatus 12. An object O in the image frame I can be represented as the user, so that the interface operating method can detect information of the moving object O to compute a position parameter of the camera apparatus 12 relative to a reference plane R whereon the object O is located.

The camera apparatus 12 can be used to detect the pedestrian movement. The mobile device 10 can be connected to the camera apparatus 12 in a remote controlling manner. The user can stand inside the monitoring region of the camera apparatus 12 and follow an indication displayed on the screen 14 of the mobile device 10 to change its position, and the processor 16 can execute the interface operating method of the present invention in accordance with variation of the object O inside the image frame I. For example, a distance between a head and a foot of the object O can be detected and computed to rapidly estimate the position parameter, such as a height H and an inclination angle θ of the camera apparatus 12 relative to the reference plane R. The known position parameter about installation of the camera apparatus 12 can be used to not only effectively decrease computation loading of the pedestrian movement detection but also increase accuracy of the pedestrian movement detection.

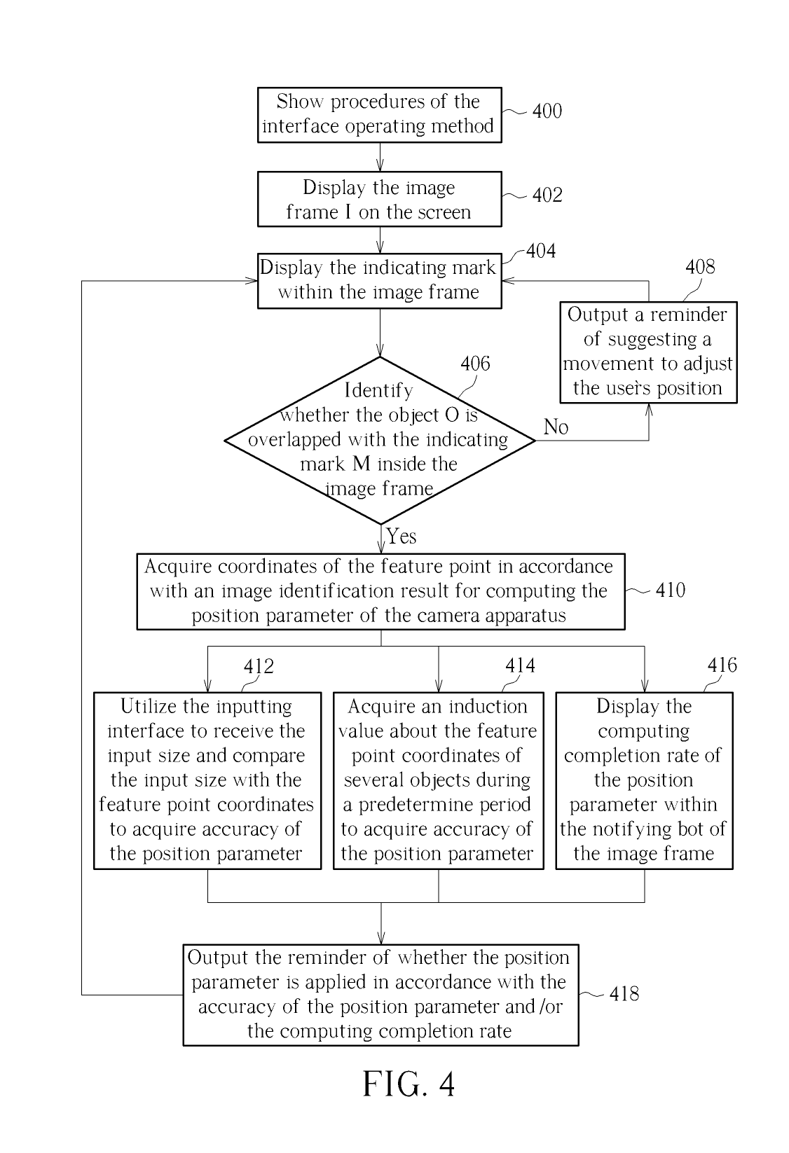

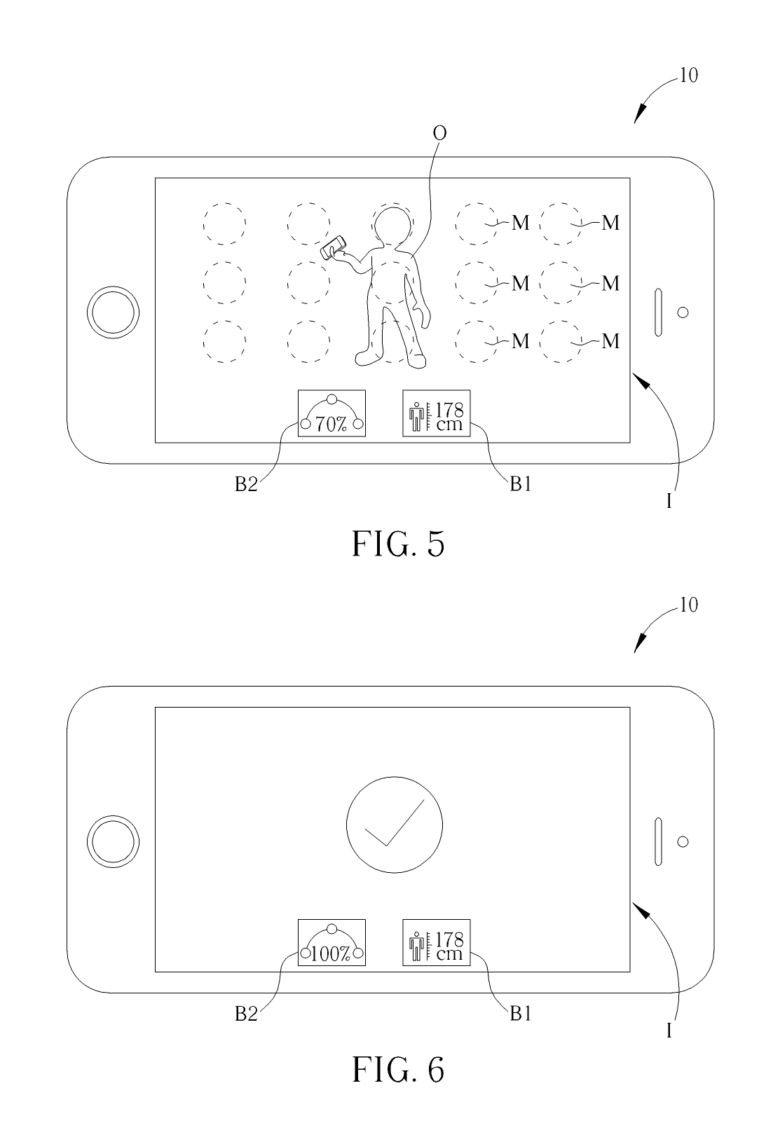

Please refer to FIG. 3 to FIG. 6. FIG. 4 is a flow chart of the interface operating method according to the embodiment of the present invention. FIG. 5 and FIG. 6 respectively are diagrams of frames about the screen 14 in different interface operating modes according to the embodiment of the present invention. Step 400 is executed to show procedures of the interface operating method on the screen 14. Steps 402 and 404 are executed to display the image frame I on the screen 14, and display one or more indicating marks M within the image frame I, as shown in FIG. 5. The user is positioned inside the monitoring region of the camera apparatus 12, and the object O of the image frame I is a pattern about the user. Then, step 406 is executed to identify whether the object O is overlapped with the indicating mark M inside the image frame I. As an overlapping completion rate of the object O overlapped with the indicating mark M is inferior to a preset value, step 408 is executed to output a reminder of suggesting the movement to adjust the user's position so that the object O is able to overlap the indicating mark M. As the overlapping completion rate of the object O overlapped with the indicating mark M is superior to the preset value, step 410 is executed to acquire a plurality of feature point coordinates and related vectors in accordance with an image identification result of the object O for computing the position parameter of the camera apparatus 12 accordingly. An overlap about the object O and the indicating mark M is represented as a pattern related to the indicating mark M is covered with a pattern related to the object O within the image frame.

In the embodiment, the indicating mark M can be removed when the said indicating mark M is overlapped with the object O, so as to remind that the overlap about the removed indicating mark M is completed and the object O can be guided to overlap other indicating marks M. In another embodiment, a new-added indicating mark can be generated at an unused position when the indicating mark M overlapped with the object O is removed, so that the object O can continue to overlap the new-added indicating mark for achieving the overlapping completion rate, and the position parameter of the camera apparatus can be estimated accordingly. For example, the interface operating method can display six indicating marks M on the image frame I, and an amount of the indicating mark is not limited to the above-mentioned embodiment. When the object O is overlapped with one of the indicating marks M, the overlapped indicating mark M can be removed from the image frame I, and the interface operating method can display the new-added indicating mark M on the unused position within the image frame I. The unused position means there is no indicating mark placed. The image frame I does not have plenty of indicating marks M at one time; therefore, the interface operating method is good for user's observation and can be used to guide the user toward a specific direction or a specific position for achieving the preset overlapping completion rate.

When the feature point coordinates and the related vectors of the object O are acquired, step 412 is optionally executed to input a known size of the object O via an inputting interface, as an input box B1 shown in FIG. 5. The interface operating method can utilize the inputting interface to acquire the input size and compare the input size with the feature point coordinates and the vectors. The position parameter may have preferred accuracy when difference between the input size and the feature point coordinates is less than a threshold. When the difference between the input size and the feature point coordinates is greater than the threshold, step 404 can be executed again to estimate the position parameter. The inputting interface can be a touch interface of the screen 14, or an external keyboard or an external mouse. In addition, the interface operating method can optionally execute step 414 to acquire the feature point coordinates of several objects O during a predetermine period, and compute the accuracy of the position parameter in accordance with an induction value about the feature point coordinates and the vectors. For example, if an average height of residents in the monitoring region is known and the feature point coordinates of several objects O are acquired during the predetermine period, the position parameter may have bad accuracy when the induction value about the feature point coordinates and the vectors is unlike the known average height, and step 404 can be executed again to estimate the position parameter.

Steps 412 and 414 can be executed according to an actual demand and is not limited in order shown in FIG. 4. Steps 412 and 414 can be executed alternatively or sequentially for verifying correction of the feature point coordinates and the vectors acquired in step 410, and the accuracy of the position parameter of the camera apparatus 12 can be increased accordingly. Step 414 can estimate the accuracy of the position parameter in an inductive manner, so that the interface operating method can further provide an amending procedure to ensure the correction of an induction result. For example, the interface operating method can detect feature point coordinates of another object O within the image frame I, and acquire the known size of the foresaid object O via the inputting interface input by the user. The input size of the object O can be compared with the feature point coordinates and the vectors. The induction result is correct when the input size is approximate to the feature point coordinates and the vectors. As the input size is unlike the feature point coordinates and the vectors, the induction result is incorrect and the interface operating method can output the reminder of whether the position parameter is in need of re-adjustment. The reminder can be displayed on the screen 14 and seen by the user.

The interface operating method can execute steps 416 and 418 to display a computing completion rate of the position parameter within a notifying bot B2 of the image frame I, and output the reminder of whether the position parameter is applied in accordance with the accuracy of the position parameter illustrated in step 412 or step 414 and/or the computing completion rate illustrated in step 416, as a tick icon shown in FIG. 6. A design of the reminder is not limited to the tick icon, and depends on design demand. Step 416 can not only be executed to immediately display the computing completion rate of the position parameter after operation of step 410, but also be executed after step 412 and/or step 414. Further, step 416 may be executed to immediately display the computing completion rate in accordance with an amount of the effective feature point coordinates acquired by identifying the object O in step 410. When the position parameter computed by the foresaid steps does not have the preferred accuracy, the interface operating method can display the reminder of a low computing completion rate via the notifying box B2. When the computed position parameter has the preferred accuracy, the reminder of a high computing completion rate can be displayed via the notifying box B2, and the user will know that the current position parameter is usable. In another embodiment, the computing completion rate can be marked by colors or percentages, for example, the red icon is represented as the low computing completion rate and the green icon is represented as the high computing completion rate, or the computing completion rate is represented by numerals. Expression of the computing completion rate is not limited to the foresaid embodiments, and depends on design demand.

As shown in FIG. 3, one or more indicating marks M can be displayed on the image frame I. A position and an amount of the indicating mark M within the image frame I can be manually set according to an obstacle inside the monitoring region, or can be automatically set for finding out the indicating marks M capable of being used to rapidly estimate the correct position parameter. The user can move inside the monitoring region in the light of the indicating marks M to overlap the object O and the indicating marks M in sequence. Data correction estimated by the feature point coordinates and the vectors of the object O can correspond to the amount of the indicating mark M and the overlapping completion rate about the indicating mark M and the object O. In addition, the plurality of indicating marks M can be displayed on the image frame I continuously or intermittently, and the user can decide a path of the advised movement via the indicating marks M. Further, the plurality of indicating marks M can be displayed on the image frame I in overlap order; when the object O is overlapped with the indicating mark M, the overlapped indicating mark M can be removed and another indicating mark M is appeared accordingly for path suggestion.

The image frame I may display the plurality of indicating marks M simultaneously or individually. The interface operating method can analyze an auxiliary degree of each of the indicating marks M for computation of the position parameter, and then mark the plurality of indicating marks M by different colors or numerals. For example, the plurality of indicating marks M is assigned serial numbers in the overlap order, and then the user can overlap the indicating marks M according to the serial numbers. Further, the plurality of indicating marks M can be marked by different colors or the same color with different depths, and the user can sequentially move to the positions overlapped with the indicating marks M until at least one of the accuracy of the position parameter and the computing completion rate conforms to preset standard. The computing completion rate corresponds to the overlapping completion rate about the object O overlapped with the indicating mark M, that is to say, a value of the computing completion rate can be increased in accordance with an amount of the overlapped indicating mark M.

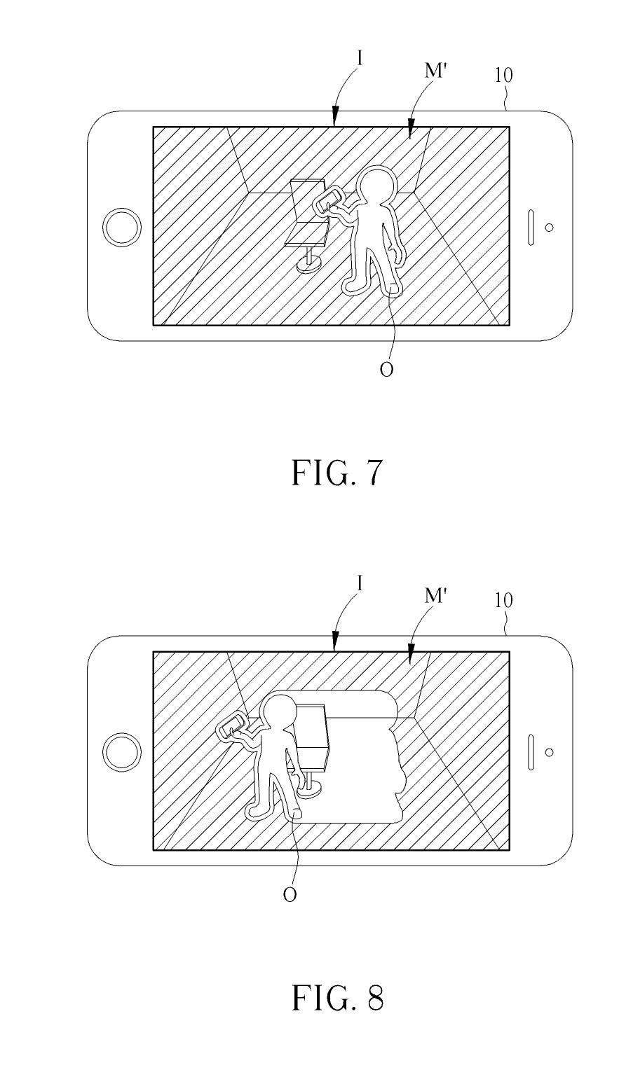

In another possible embodiment, the indicating mark M′ can be a blurred pattern covering the image frame I. Please refer to FIG. 7 and FIG. 8. FIG. 7 and FIG. 8 respectively are diagrams of the image frame I having the indicating mark M′ indifferent interface operating modes according to another embodiment of the present invention. In this embodiment, the indicating mark M′ can be the blurred pattern fully or partly covering the image frame I but excluded a contour of the object O. The blurred pattern shown in FIG. 7 can utilize slash symbols to indicate the indicating mark M′; however, the indicating mark M′ may be a dotted pattern, a nebulized pattern, a mosaic pattern, or an opaque colorful pattern (such as black color or gray color). When the object O is appeared on the image frame I, the interface operating method can determine the object O is overlapped with a small part (a small region around the object O) of the indicating mark M′, and the small part of the blurred pattern can be removed to expose the clear background, as shown in FIG. 7. When the user moves inside the monitoring region, the blurred pattern (which means the indicating mark M′) getting past by the moving path of the object O can be gradually removed, as shown in FIG. 8. The feature point coordinates can be acquired until a removal of the blurred pattern (which means the indicating mark M′) on the image frame I is achieved to the preset overlapping completion rate, and then the position parameter of the camera apparatus 12 can be computed accordingly.

In conclusion, the interface operating method of the present invention is applied to the mobile device. The user can move inside a place (which means the monitoring region) captured by the camera apparatus in accordance with the image frame of the mobile device. The interface operating method can show the plurality of indicating marks on the image frame corresponding to the monitoring region. The user can move to some specific positions by following the indicating marks, and the camera apparatus can capture patterns about the user. The interface operating method can estimate the vector of the patterns about the user via the feature point coordinates of the object, and compare the estimated value with the known height of the user for computing the height and the inclination angle of the camera apparatus relative to the reference plane. The estimated value can be similar to the known height of the user by the object overlapping plenty of the indicating marks within the image frame. The present invention further provides several verification procedures to ensure the accuracy of the position parameter about the camera apparatus.

Comparing to the prior art, the user can independently operate the interface operating method of the present invention without an extra cooperator near by the camera apparatus. The user can look at the screen of the mobile device to decide the following motion and positions. The user does not move to useless positions so that an operation period can be economized and operation efficiency can be increased. The interface operating method of the present invention can decrease computation loading by computing the computing completion rate of the position parameter according to collected data (which means the feature point coordinates of the object overlapped with the indicating mark), so as to point out that the interface operating method is continued or completed. The user can utilize the verification procedures of the interface operating method to check the accuracy of the position parameter when still being positioned in the monitoring region. As the accuracy is insufficient, the interface operating method can be executed again to suggest the movement of the user for overlapping the indicating mark and acquiring the updated feature point coordinates and the updated position parameter The computer screen of the camera apparatus may be distant from the monitoring region, for example, the monitoring region is about an entrance of a market and the computer screen is set in an administration center of the market, so that the user having the mobile device with the interface operating method of the present invention does not need to move back and forth between the entrance and the administration center.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An interface operating method, comprising:
displaying an image frame captured by a camera apparatus;
displaying at least one indicating mark on the image frame;
identifying whether a position of an object appeared on the image frame is overlapped with the at least one indicating mark; and
acquiring a plurality of feature point coordinates of the object in accordance with an identifying result for computing a position parameter of the camera apparatus relative to a reference plane whereon the object is located.

2. The interface operating method of claim 1, further comprising:
displaying a computing completion rate of the position parameter on the image frame; and
outputting a reminder of whether the position parameter is applied in accordance with the computing completion rate.

3. The interface operating method of claim 1, further comprising:
receiving an input size via an inputting interface;
comparing the input size with the plurality of feature point coordinates for acquiring accuracy of the position parameter; and
outputting a reminder of whether the position parameter is applied in accordance with the accuracy of the position parameter.

4. The interface operating method of claim 1, further comprising:
acquiring the plurality of feature point coordinates of several objects within a predetermine period;
acquiring accuracy of the position parameter in accordance with an induction value about the plurality of feature point coordinates; and
outputting a reminder of whether the position parameter is applied in accordance with the accuracy of the position parameter.

5. The interface operating method of claim 4, further comprising:
detecting a plurality of feature point coordinates of another object on the image frame;
utilizing an inputting interface to acquire an input size; and
outputting a reminder of whether the position parameter is adjusted in accordance with difference between the input size and the plurality of feature point coordinates of the said object.

6. The interface operating method of claim 1, wherein a plurality of indicating marks is displayed on the image frame, the plurality of feature point coordinates is acquired in accordance with an overlapping completion rate of the object and the plurality of indicating marks.

7. The interface operating method of claim 6, wherein the plurality of indicating marks is simultaneously displayed on the image frame, or displayed on the image frame in overlap order.

8. The interface operating method of claim 6, wherein computation accuracy of the plurality of indicating marks relative to the position parameter is analyzed and respectively marked by specific symbols.

9. The interface operating method of claim 6, wherein the plurality of indicating marks is marked by different colors or different numerals.

10. The interface operating method of claim 2, wherein the computing completion rate corresponds to an overlapping completion rate of the object overlapped with the at least one indicating mark.

11. The interface operating method of claim 1, wherein the position parameter is at least one of a height and an inclination angle of the camera apparatus relative to the reference plane.

12. The interface operating method of claim 1, wherein the at least one indicating mark is a blurred pattern covering the image frame.

13. A mobile device connected with a camera apparatus in a remote controlling manner for guiding a movement of a user to estimate a position parameter of the camera apparatus, the mobile device comprising:
a screen configured to display an image frame captured by the camera apparatus; and
a processor electrically connected to the screen and configured to display at least one indicating mark on the image frame, to identify whether a position of an object appeared on the image frame is overlapped with the at least one indicating mark, and to acquire a plurality of feature point coordinates of the object in accordance with an identifying result for computing position parameter of the camera apparatus relative to a reference plane whereon the object is located.

14. The mobile device of claim 13, wherein the processor is further configured to display a computing completion rate of the position parameter on the image frame, and output a reminder of whether the position parameter is applied in accordance with the computing completion rate.

15. The mobile device of claim 13, wherein the processor is further configured to receive an input size via an inputting interface, compare the input size with the plurality of feature point coordinates for acquiring accuracy of the position parameter, and output a reminder of whether the position parameter is applied in accordance with the accuracy of the position parameter.

16. The mobile device of claim 13, wherein the processor is further configured to acquire the plurality of feature point coordinates of several objects within a predetermine period, acquire accuracy of the position parameter in accordance with an induction value about the plurality of feature point coordinates, and output a reminder of whether the position parameter is applied in accordance with the accuracy of the position parameter.

17. The mobile device of claim 16, wherein the processor is further configured to detect a plurality of feature point coordinates of another object on the image frame, utilize an inputting interface to acquire an input size, and output a reminder of whether the position parameter is adjusted in accordance with difference between the input size and the plurality of feature point coordinates of the said object.

18. The mobile device of claim 13, wherein the processor is configured to display a plurality of indicating marks on the image frame, so as to acquire the plurality of feature point coordinates in accordance with an overlapping completion rate of the object and the plurality of indicating marks.

19. The mobile device of claim 14, wherein the computing completion rate corresponds to an overlapping completion rate of the object overlapped with the at least one indicating mark.

20. The mobile device of claim 13, wherein the position parameter is at least one of a height and an inclination angle of the camera apparatus relative to the reference plane.
